(19) United States
(12) Patent Application Publication
(10) Pub. No.: US 2015/0260620 A1
(43) Pub. Date: Sep. 17, 2015

(54) DEVICE FOR AUTOMATICALLY STAINING GLASS SLIDES

(71) Applicant: Sergio Cometto, Torino (IT)

(72) Inventor: Sergio Cometto, Torino (IT)

(73) Assignees: INTELSINT S.r.l., Torino (IT); Bio - Optica Milano S.P.A., Milano (IT)

(21) Appl. No.: 14/407,909

(22) PCT Filed: Jun. 12, 2012
(86) PCT No.: PCT/IT2012/000177

§ 371 Date: May 25, 2015

(51) Int. Cl. G01N 1/31; G01N 35/02; G01N 35/10; G01N 35/00

(52) U.S. Cl. CPC G01N 1/312; G01N 35/00029; G01N 35/021; G01N 35/1002

(57) ABSTRACT

The present invention relates to equipment for the automatic staining of biological samples, comprising:
a staining unit able to house one or a plurality of staining trays organised in a matrix and able to house a slide-holder basket, said staining unit further comprising drive means of the slide-holder baskets;
and an automatic system for maintaining and replacing the reagents,
characterised by the fact that said drive means of said baskets comprise means for maintaining and replacing the reagent/stain inside a tray.

The present invention relates to a device for staining the slides used in the analysis of histological samples.

Examination under the optical microscope today still represents an essential and largely irreplaceable instrument for the diagnosis of serious diseases, in that it permits the analysis and study of the morphology of tissues and cells, thereby making it possible to identify the microorganisms responsible for serious diseases such as neoplastic cells.

Similarly, such analysis may also be performed on plant cells.

The sample to be analysed is placed on a normal slide for optical microscopy and is typically represented by a slice of the biological tissue included in paraffin, by a cellular strip, by material obtained from needle biopsies etc. It is known that such samples are generally diaphanous and in order to be analysed need to be stained to highlight the structure and the various components.

Generally speaking, three main staining types exist
routine staining;
special staining;
Immunohistochemical staining;

All staining processes are very important, in that only if performed properly do they enable the various cells and differently organised tissues to be distinguished from each other thanks to the improvement of the contrast or different colour assumed.

It is normal for various methods to be performed in the laboratory; to cite one example, in anatomical pathology labs the main routine stainings are:
hematoxylin-eosin;
papanicolaou.

It is also perfectly normal for the same equipment to be used for different stainings.

In the past, the various staining steps of tissues for histological or cytological analysis were performed manually. This inevitably led to results which were non-uniform, hard to repeat and difficult to compare.

Modern methods are instead automated and generally comprise two different methods for the application of reagents to samples:
methods based on the application of the reagent directly to the individual slide, which is placed inside a grid in a horizontal position (see for example the patent application US 2004/0002163 on behalf of Ventana);
methods using the “immersion” (also known as “dip and dunk”) technique.

Immersion techniques are often used for routine staining given the considerable quantity of samples which need to be prepared. In particular, in this method, a certain number of slides are positioned in special housings inside baskets, which are immerged in sequence in trays containing the reagent or stain.

However the laboratory technician remains responsible for maintaining the reagents and namely filling the trays with the correct reagent, emptying them at the end of the cycle, cleaning the residue of tissues and stains, drying and repositioning them in the right seat.

Such procedures are certainly wasteful in terms of time and expose personnel to the risks deriving from contact with potentially hazardous or toxic chemical substances.

In the same way, the risk of error in the positioning of the trays or in the cleaning protocols is introduced, with imaginable consequences on the result of the staining process which may have to be repeated.

Consequently, a piece of equipment needs to be developed which is able manage entirely automatically not only the steps of staining the sample but also the maintenance and replacement of the various reagents.

Another not infrequent different problem in the field of histological analyses is represented by the cross-contamination of samples.

In fact, as mentioned above, nowadays instruments are commonly used which enable both the automatic and manual contemporary processing of a number of slides inserted inside the same basket.

During the staining process it is not infrequent in fact for small fragments of sample to detach from a slide and deposit on another slide.

This may happen during any of the processing steps which may be multiple depending on the type of protocol envisaged, but is however a typical problem of the “deparaffining” step. In particular, in this first step, common to the various staining methods, the paraffin impregnating the sample is removed by immersion in xylene.

This operation is usually the most delicate, precisely because it is the first in which the sample is handled.

It may be noted therefore, that precisely in this step, small fragments of tissue, or even single cells, which were not thoroughly stuck to the surfaces, detach from the slide, thereby creating the conditions for a cross-contamination of another sample.

In fact, it is known that the adhesion of the “slice” of sample, generally 2-4 μm thick, is given by the natural adhesion of the biological material to the slide, which cannot by its nature be either controlled or completely verified.

The problem arises when these fragments deposit themselves on another slide, thereby causing a potential diagnostic error.

Despite the treatment with xylene being substantially the most energetic, as said above, one cannot however rule out that the same problem may arise during other staining or washing steps, perhaps precisely on account of the weakening of the adhesion of the sample during the first phase. This problem has been widely faced in literature, for example in Platt E. in Arch Pathol Lab Med—Vol 133, June 2009 and in Gordon N. Gephardt in Arch Pathol Lab Med—Vol 120, November 1996.

Therefore, a need is recognised to develop equipment, possibly automatic, which is able to resolve the problem of maintenance and replacement of the reagents and which can prevent the cross-contamination of the various samples during the staining process.

Such equipment would simplify the processing operations of the samples and make the diagnostic results more reliable with an evident advantage in terms of time and money.

### OBJECT OF THE INVENTION

A first embodiments of the invention is represented by the equipment defined in claim 1 and by the dependent claims, for the automatic staining of biological samples according to the dip and dunk immersion method which automatically maintains the reagents.

According to a further embodiment, a system is described for the maintenance and at least partial replacement of the single reagent inside its tray. In another embodiment, the invention describes equipment and a method for preventing the cross contamination of biological samples on slides for histological analysis caused by fragments of biological samples migrating from one slide to another.

### BRIEF DESCRIPTION OF THE DRAWINGS

FIG. 1 is a schematic representation of the equipment able to manage the stains/reagents;

FIG. 2 shows a detail of the equipment;

FIGS. 3A, 3B and 3C shows details of the end-effector;

FIG. 4 shows a piece of equipment according to the present invention;

FIG. 5 schematises the relations between the units of the centralised control system;

FIG. 6 shows the integrated system of the staining trays for the maintenance and replacement of the stain/reagent;

FIG. 7 shows examples of stains and stainings;

FIG. 8 shows diagrams relative to several staining protocols.

### DETAILED DESCRIPTION OF THE INVENTION

According to a first embodiment, the present invention relates to a piece of equipment 1 for the automatic staining of slides comprising:
a staining unit 2 with trays 3; and
an automatic system 6 (or SAGR) for maintaining and replacing the reagents.

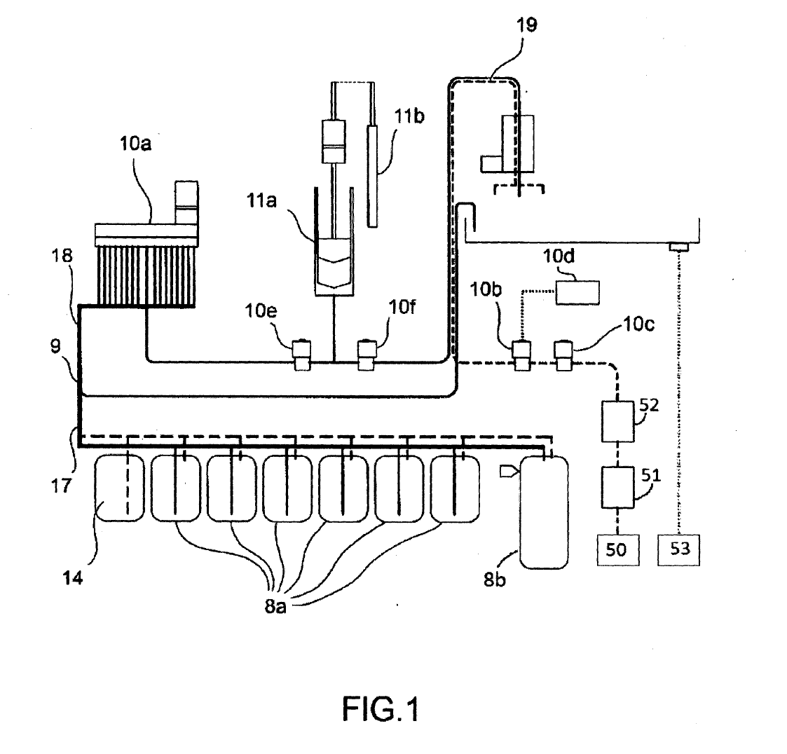

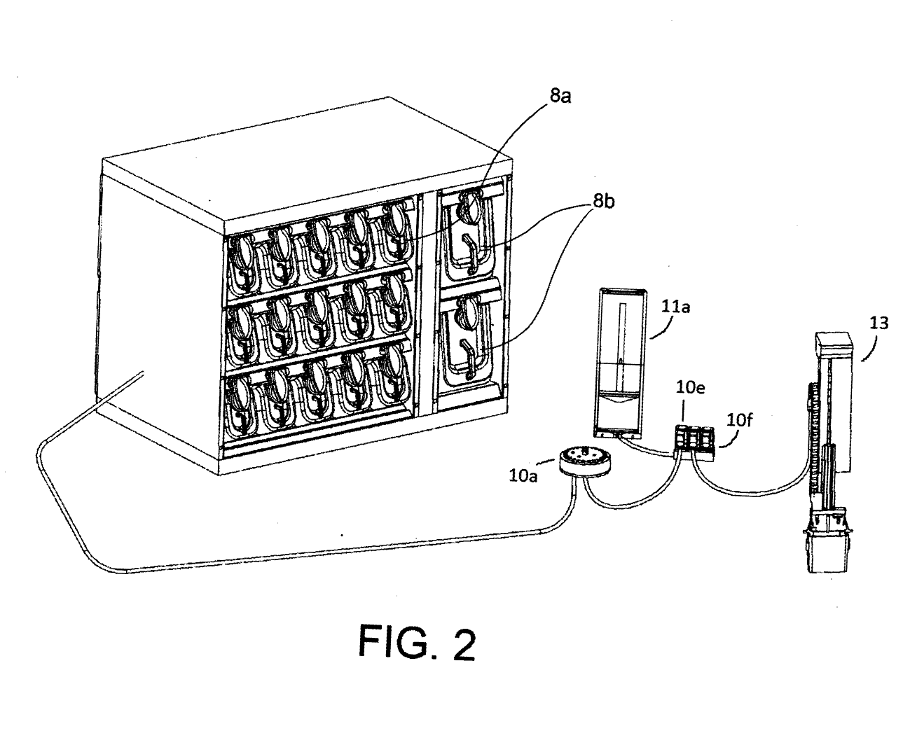

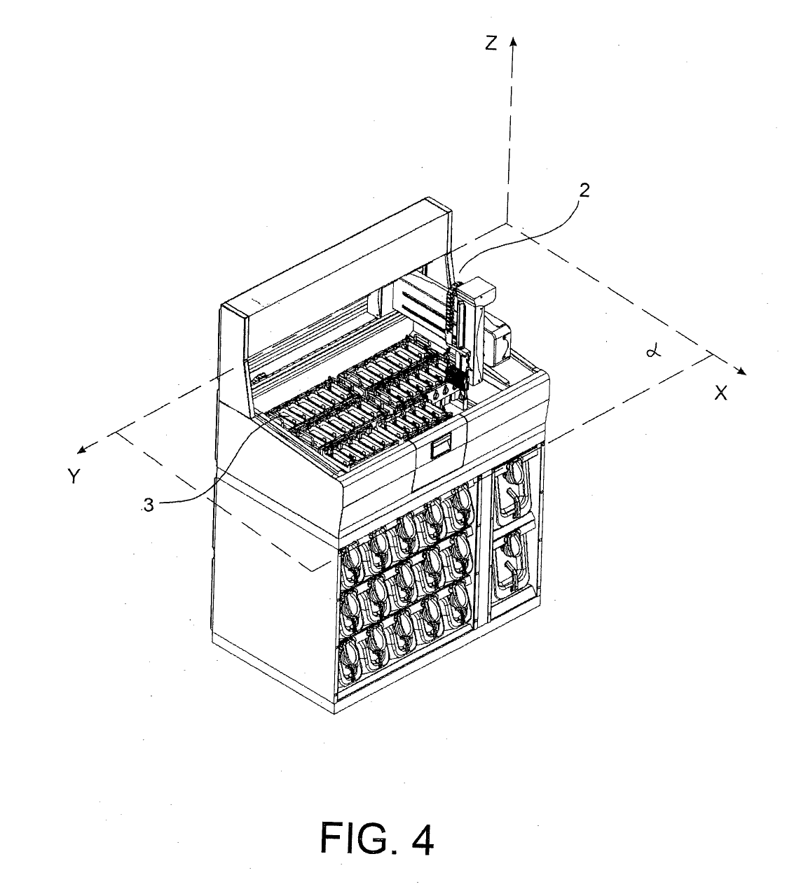

In particular, the staining unit with trays 2 is represented by an immersion staining unit of the known type (such as represented in FIGS. 1, 3B and 4), comprising one or, more generally, a plurality of staining trays 3 able to receive a basket 4 holding the slides 26. To be able to resist the reagents/stains used, such trays 3 are normally coated internally with a suitable material, preferably water-repellent, for example such as polytetrafluoroethylene (PTFE). In addition, a series of reservoirs (indicated by reference numeral 8a in FIGS. 1 and 4) containing the “new” stains/reagents, in other words to be used for the maintenance and replacement of the process reagents and for the disposal of the “used” stains/reagents, that is to say after their use (indicated by reference numeral 8b in FIGS. 1 and 4) are housed in the staining unit 2.

A level sensor (not shown in the figures) may be provided for each reservoir to verify its degree of fullness/emptiness.

Depending on the type of chemical product used and also on the safety regulations, only one or several reservoirs may be provided for separate waste disposal.

For some reagents/stains (such as water), collection may be provided for both inside dedicated reservoirs or if possible and permitted by legislation, disposed of directly into the drains.

To prevent the diffusion of possible vapours, the piece of equipment may also be fitted with special means (indicated by reference numeral 14 in FIG. 1), for example consisting of a carbon filter, for the purpose of absorbing any vapours and/or odours released by the reagents/stains and thereby meeting the requirements dictated by safety legislation.

The circulation of the stains/reagents in the equipment 1 is achieved thanks to a distribution circuit 9 which in particular comprises the sub-circuits for:
channeling the stains/reagents from the storage reservoir to the staining trays (indicated by reference numeral 17 in FIG. 1);
bringing the stains/reagents from the stain trays to the disposal reservoir or drain network 53 (indicated by reference numeral 18 in FIG. 1);
distributing the water (indicated by reference numeral 19 in FIG. 1).

From a structural point of view, the tubing which such circuits are made from is generally in a suitable material, preferably flexible and resistant to the reagents (such as Viton®).

Auxiliary means 10 for the circulation of the stains/reagents, such as for example valves and pumps may also be envisaged.

For example, valves may be provided on the output from the reservoirs (such as the rotating valve shown in FIG. 1) and in the water distribution circuit 19 (indicated by 10b and 10c in FIG. 1). But then a person skilled in the art may envisage the insertion of pumps in suitable points, such as for example indicated in FIG. 1 by 10d), for example connected to a valve.

Special dosing means 11 are provided for dosing the liquids in the trays 3, such as for example one or more dosing syringes 11a, which are in turn controlled by a linear encoder 11b.

The insertion of further valves in input and output from the dosing syringe 11a for controlling its filling/emptying (for example, indicated in FIG. 1 with the valve 10e placed between the valve 10a and the dosing syringe 11a, and the valve 10f placed between the dosing syringe 11a and the end-effector 13).

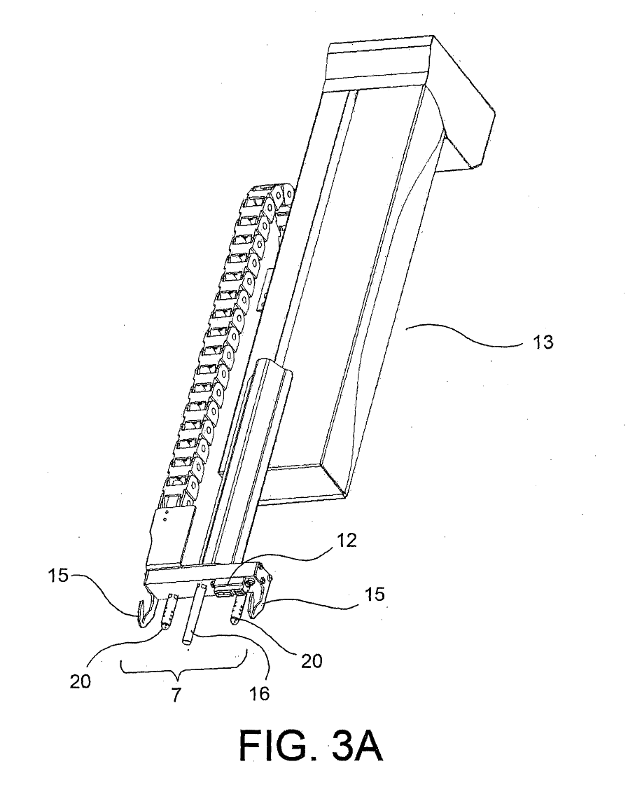

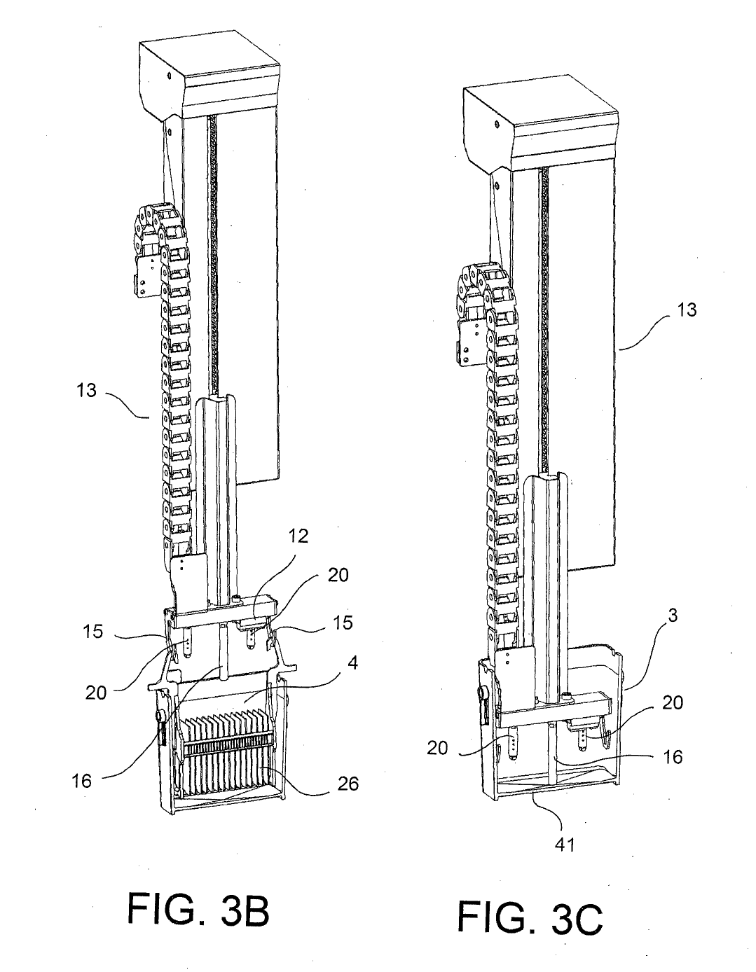

As regards the drive system of the slide-holder baskets 4, this comprises drive means 5 represented for example by an end-effector 13, for example represented by a automated arm such as that shown in FIGS. 3 and 4, able to move in the directions X-Y-Z.

As with the known staining equipment, the trays 3 are housed on a plane a delimited by the axes x and y (FIG. 4). One may therefore think of a matrix, wherein each tray 3 is distinguished and identifiable by the end-effector 13 by means of its co-ordinates on the x and y axes.

Inside each tray 3 of the staining unit one of the steps of the staining protocol will therefore take place by using a determined stain/reagent.

Within the present invention the term stain/reagent is taken to mean any product or mixture used for staining and, more generally for processing the sample, including washing.

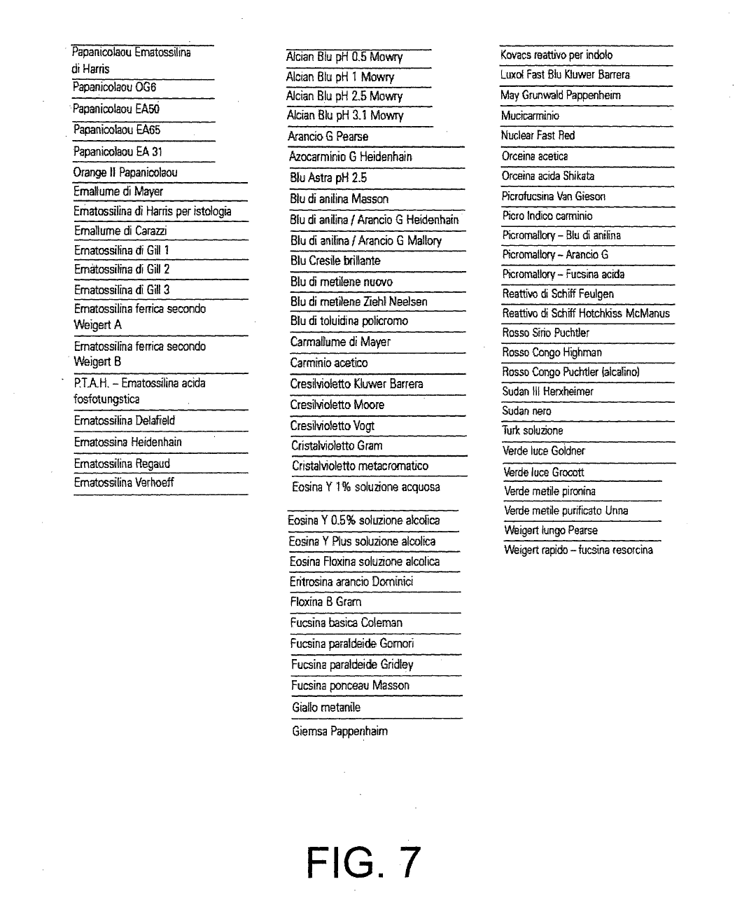

Consequently, water (distilled, ultrapure, spa (or mains, see reference 50 in FIG. 1; heated if necessary and/or filtered by appropriate means, respectively indicated by reference numerals 51 and 52), ethanol, hematoxylin, eosin, EA 60, Orange g, xylol or other diaphanizing agents known in the sector, staining solutions Papanicolaou, Alcian Blue, Water blue, azocarmine, Astra blue, methylene blue, carmallume, acetic carmine, cresyl violet, Crystal violet, Floxin, Metanil yellow, Giemsa Pappenhaim, Kovacs indole reagent, Luxol Fast Blue Kluwer Barrera, May Grunwald Pappenheim, Mucicarmine, Nuclear Fast Red, Orcein, Picro-fuchsin, Schiff Reagent, Congo Red, Sudan, Turk solution, Light green, Methyl green, Weigert, etc (FIG. 7 shows some stains mentioned above and other stains among which those of the present invention) are understood to be included.

“Staining protocol” rather is taken to means a specific sequence of operations which must be performed to process the sample.

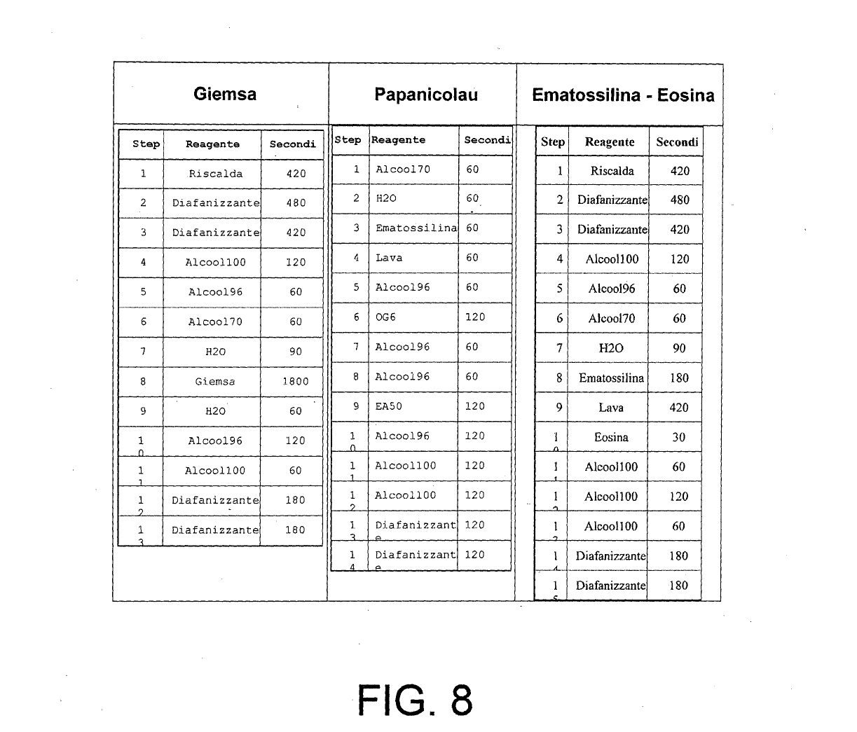

For example, FIG. 8 shows typical diagrams for the Giemsa, Papanicolaou and Hematoxylin-Eosin protocols.

As described above, the end-effector 13 is able to move thanks to its own drive system represented by an electric motor, with gear motors, cogged belts, pulleys, control systems of the position, where needed etc), so as to assume an idle configuration, for example in an elevated position and therefore not in contact with any liquid (as shown in FIG. 3B) present in the tray or an active configuration (such as that in FIG. 3C), for the filling and emptying operations of the tray.

According to a preferred aspect of the invention, such end-effector 13 (shown in FIGS. 3A, 3B and 3C) is complex, in that it comprises:

i) means 5 of coupling/releasing the slide-holder baskets 4 which can thus be moved, and
ii) means 7 for maintaining and replacing the reagent inside the tray.

More in particular, as regards the coupling/release means 15, these comprise a traditional fork structure, which is able to couple to a handle portion of the slide-holder basket 4 to a couplable portion of the basket itself, such as shown for example in FIG. 3B. This way, once coupled, the basket 4 may be moved by the drive system of the end effector 13.

The means 7 for maintaining and replacing the reagent inside the tray rather, comprise in particular:
a) means 16 of filling/emptying the tray with a stain/reagent; and/or
b) means 20 of washing the tray; and/or
c) means 12 of checking the level of stain/reagent inside the tray.

In a preferred aspect, all three means a), b) and c) are envisaged.

For the purposes of the present invention it is understood that the means 16 represent an end portion of the sub-circuits 17 and 18, while the means 20 represent an end portion of the sub-circuit 19.

As regards the means 12 of checking the level of liquid inside the tray, these may for example be represented by an infrared level sensor, such as the sensor SHARP GP2D120.

According to one aspect of the invention, the means 20 of washing the tray 3 may also be used to dry the tray 3, channeling air, if necessary hot, inside the tray. To such purpose, such means may be envisaged in fluidic communication with a compressor (not shown in the drawings).

According to another embodiment of the invention, a piece of equipment 1 is described which is able to perform the at least partial maintenance of the stain/reagent inside its tray 103.

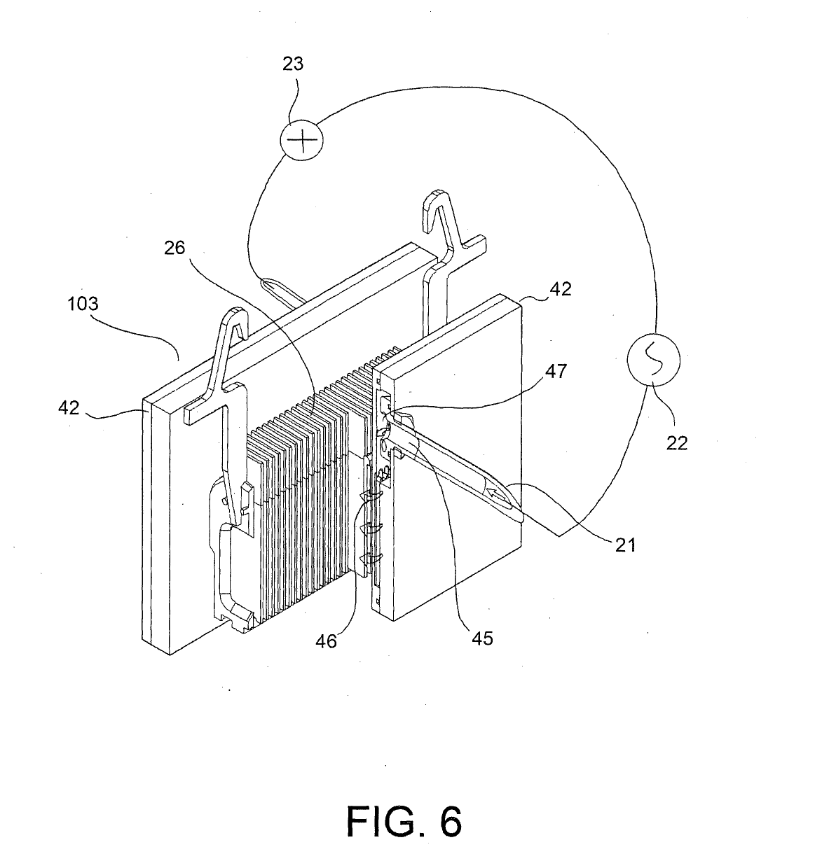

To such purpose, therefore, the piece of equipment comprises one or a plurality of trays 103 for the stain like that shown in FIG. 6 comprising a recirculation system of the reagent/stain inside the tray 103 itself.

In particular, such tray of a substantially a parallelepiped shape, comprises two complex walls 42, 42.

It will be noted that the complex walls 42 are those perpendicular to the surface of the slides 26, when these are correctly housed in the basket 4 inserted in the tray 103.

Each complex wall 42, in particular comprises in fact a through aperture 45 which enables the fluidic connection between the inside of the tray and the recirculation means 21 of the stain/reagent thereby forming a continuous and closed circuit.

According to a preferred aspect of the invention, before entering the tray the incoming fluid diffuses inside a space 47 made in the thickness of the wall 42 and subsequently diffuses inside the tray through apertures 46 distributed in the inner face of the wall 42 of the tray, so as to enable a homogeneous diffusion of the reagent/stain in the tray 103. For example, such apertures 46 may be represented by a plurality of holes suitably distanced from each other or may be represented by vertical slits (not shown in the drawings) parallel to each other. Advantageously, this way the flow which is created inside the tray is of a laminar type and parallel to the surface of the slides, when these are arranged inside the basket with the side bearing the sample facing in the same direction.

As regards such recirculation means 21 of the stain/reagent in the tray 103, these generally include a system of tubes, as mentioned above, in flexible material but at the same time resistant to corrosion (such as the Viton mentioned).

According to preferred aspect, auxiliary recirculation means 22 may be envisaged, represented, for example, by pump means.

By regulating the pump 22 the flow inside the circuit may be continuous or intermittent and the most suitable speed may be set (expressed as l/min) for the contingent requirements.

For example, a speed of about 1-10 l/min or such a speed as to achieve 8-17, preferably 10-15 recirculations, in other words full replacements of the liquid inside the tray 103, per minute may be set.

It should be noted that, as shown by the arrows in FIG. 6, such flow is able to wash away any residues of tissue not perfectly adhered to the surface of the slide, thereby preventing them from re-depositing on the same in another position or on another slide.

The advantage of preventing fragments of sample detached from a slide from contaminating another slide is therefore evident.

This considerably reduces the risk and incidence of incorrect diagnosis.

According to a preferred aspect, filtering means 23 of the reagent/stain coming out of the tray may also be envisaged.

In particular, such means 23 are placed subsequent to the output flow from the tray 103, and are preferably represented by a micron filter able to retain even the single cells detaching from a slide, placed downstream of the tray.

According to one aspect of the invention, a filter composed of various layers of filtering material in sheets with decreasing mesh apertures for example from 1 mm to 0.001 mm, fitted if necessary with a final layer in cotton (or equivalent natural or synthetic material) able to retain by adhesion or trap particles of micrometric size and even single cells, may be used.

This way, the stain/reagent is filtered and may be continually recycled.

According to a preferred aspect, the tray 103 may also comprise heating means of the reagent/stain (not shown in the drawings).

These may be represented for example by a resistor in contact with the free walls, that is which have no apertures, or by a heating jacket.

This way the liquid can be heated up to 60° C.

Obviously, it should be understood that a tray in which the aforementioned recirculation of the stain/reagent is performed in full may be part of automated equipment, such as that able to manage the maintenance of the reagent as described according to the present invention, or as a system in its own right.

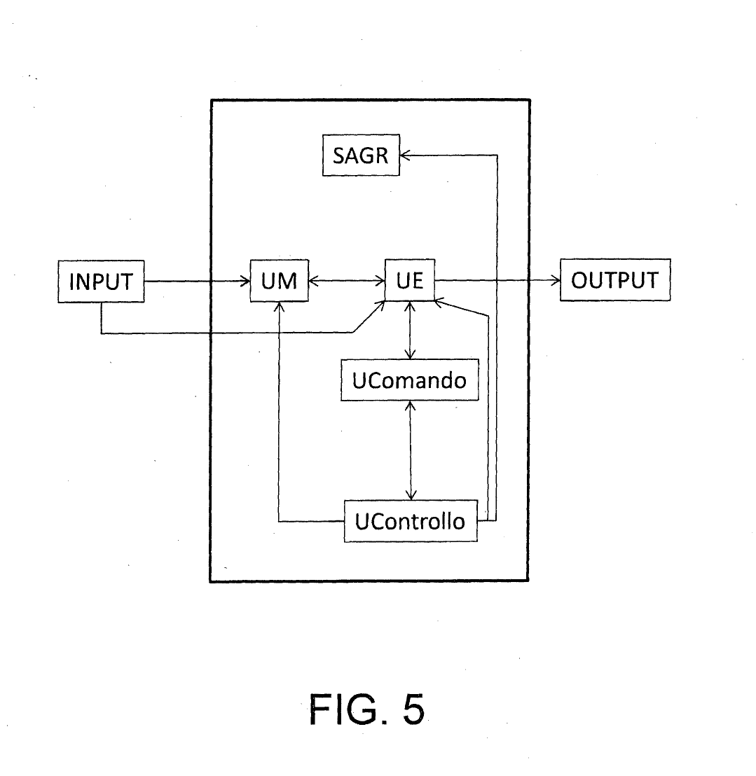

According to the present invention, the equipment described comprises an automatic stain/reagent maintenance and replacement system (SAGR), (see FIG. 5).

In particular, such system controls the operations of:
filling and emptying each tray;
emptying the distribution circuit;
washing the tray;
drying the tray;
checking the reservoir.

Even more in particular, the maintenance and replacement system (SAG) consists of a central control system (CCS) which in turn includes:
an input user interface (INPUT);
an output user interface (OUTPUT);
a memory unit (MU);
a plurality of control units (Control unit);
a processing unit (PU);
a command unit (Command unit).

As regards the INPUT interface, this enables the user, for example the lab technician, to feed in and set data regarding:
co-ordinates relative to the position of the trays;
staining protocol;
instructions concerning the maintenance and replacement of the reagents (such as threshold value of the reagents/stains at which replacement must be carried out, number of samples to be treated etc);
information concerning the replacement of the reagents;
other data such as, for example, the expiry date of each reagent/stain, the expiry date of the filters etc.

The memory unit (MU) instead records the information acquired through the INPUT interface and that coming from an assessment of the equipment status via the control unit. The memory unit sends information to the processing unit and to the OUTPUT user interface.

As regards the processing unit (PU), this is configured to process assessments and statistics (consumption of reagent/stain per process, estimates of the costs of the reagents etc) on the basis of data directly fed in by the operator and/or memorised in the memory unit or received from the control unit.

The control units (Control unit) permit control of the equipment status; in particular these comprise the liquid level sensors (in the tray, in the storage and disposal reservoirs) the valves, the pumps, the dosing syringe, recirculation means, heating means, end-effector.

As regards the OUTPUT interface rather, this enables the user to get information or confirmation of information about:
equipment status (level of the reagents, quality of the reagents, filter status etc);
status of the staining processes in progress;
status of the maintenance processes.

As regards the command unit (Commando unit), this controls the activities:
movement of the end-effector;
opening/closing of the storage and disposal reservoir valves;
functioning of the pumps;
functioning of the dosing syringe;
functioning of the heating system;
functioning of the compressor;

For a clearer understanding of the functioning of the equipment of the present invention, an example of how the maintenance of the reagent is performed is described below.

### Maintenance Cycle of the Reagent

Consider the starting situation, in which the stain trays are full, the reservoirs (tanks) of new stains/reagents (fresh) are full, while the reservoirs of used stains/reagents are empty. In addition, the end-effector is in the maintain tray position, in which the basket is not present.

The sequence of steps is:
1) emptying of the used reagent from the tray to the reservoir (8b) of used reagent or to the drain;
2) washing of the tray;
3) drying of the tray;
4) filling of the tray with the new opportune reagent/stain based on the staining protocol.

Optionally, before the filling step 4) an emptying step of the channeling means of the reagent/stain may be envisaged when necessary.

In particular, the command unit controls the emptying of the tray according to step 1), in which the end effector 13 places itself at draught height, that is, at a height along the axis z such as to enable the suction of the stain/reagent by the emptying means 16. To enable complete emptying it is envisaged that the end-effector moves as far as a limit stop, reaching the bottom 41 of the tray.

It is to be noted that, according to a preferred aspect of the invention, the bottom (41) of the staining tray may have a minimum point as opposed to being flat, in other words is substantially concave, for example in the shape of an overturned pyramid (as shown in FIG. 3C). This way, it is advantageously easier to achieve the complete emptying at the end of the cycle, improving thereby the efficiency of the cleaning process.

Depending on the nature of the stain/reagent, the content of the tray is subsequently expelled:
if it is a stain/reagent which can be disposed of into the network, into the drain;
if it is a stain/reagent which must be disposed of according to special procedures, this is collected in special reservoirs which may also collect other stains/reagents if necessary.

In step 2) of washing the tray rather, the end-effector is in a lower stroke position (as shown in FIG. 3C.) This is followed by the opening of the valves 10b and 10c of the water distribution circuit 19. The tray is then filled with the washing liquid by the means 16 of the end-effector. In particular, the maintenance and central replacement system may send command signals to the end-effector, so that during the filling step this rises along the axis z gradually as the level of liquid increases. After which the valve closes and the tray is emptied according to the procedure detailed above.

The central control system may be set so that the operation is repeated a number of times so as to ensure efficient washing of the tray.

In the drying step 3) rather, the end-effector is in an active suction position and preferably at the bottom of its stroke. The drying proceeds thank to the pumping of air by the pump 10d. The control system can also command the end-effector to continue to move from a position at the bottom of its stroke to the upper position continuously, so as to achieve an efficient drying of the tray.

In the optional emptying step of the channeling means of the stains/reagents air is aspirated from the tray by the dosing syringe 11a. More in detail, with reference to FIG. 1, the valve 10e is in a closed position, the valve 10f is in an open position and the end-effector 13 is a non draught position (FIG. 3B). In this configuration the syringe 11a proceeds with the aspiration of air. Closing of the valve 10f, opening of the valve 10e and the expulsion of the contents of the syringe 11a into the dedicated reservoir follows.

The central control system can be set so that the operation can be repeated a sufficient number of times depending on the type of stain/reagent so as to achieve an efficient emptying of the tubes.

The numerous advantages of the equipment described by the present invention will be evident from the above.

First of all, the maintenance and automated replacement of the reagent makes it possible to reduce the times normally spent by a lab technician to change the reagents/stains, check their levels and quality.

In fact, the maintenance and replacement operations of the equipment are more efficacious, in the sense that they are put into action at the most opportune and efficient moment inasmuch as deriving from automated processing rather than from subjective assessments made by a person, even if expert.

As a result, a reduction of the operating cost of the machine also ensues.

As regards cleaning the tray too, this can be performed at the end of the cycle that is for example at the end of the working day or whenever deemed necessary on the basis of the staining protocol to be followed, so as to maintain a standard level of cleanliness of the trays.

But then, the system which controls the recirculation of the reagent inside the tray represents a significant improvement in the reliability of the results of analysis. In fact, it permits a drastic reduction of the possibility of cross-contamination between different slides. In addition, the possibility of connecting the equipment control system to the management system of the laboratory it is used in so as to meet the traceability requirement of the sample and constantly monitor the quality of the reagents, standards which are essential today for laboratories to comply with ISO guidelines and therefore for the certification of such laboratories, is no secondary matter.

From the above description, a person skilled in the art, may make numerous modifications and additions, replacing elements with others functionally equivalent while remaining within the sphere of protection of the following claims. Each of the characteristics described as belonging to a possible embodiment may be realised independently of the other embodiments described.

1-38. (canceled)

39. Equipment for the automatic staining of biological samples, comprising:
(i) a staining unit able to house one or a plurality of staining trays organized in a matrix and able to house a slide-holder basket, said staining unit further comprising drive means of the basket holding the slides; and
(ii) an automatic system for maintaining and replacing stains/reagents, characterized by the fact that said drive means of said basket comprise means for maintaining and replacing the reagent/stain inside a tray.

40. Equipment for the automatic staining of biological samples according to claim 39 comprising reservoirs of new and used stains/reagents.

41. Equipment for the automatic staining of biological samples according to claim 39 comprising a distribution circuit in turn comprising sub-circuits:
(i) for channeling the stains/reagents from the storage reservoirs to the staining trays;
(ii) for channeling the stains/reagents from the staining trays to the disposal reservoirs or drainage network; and
(iii) to distribute water.

42. Equipment for the automatic staining of biological samples according to claim 39, further comprising auxiliary means for the circulation of the stains/reagents.

43. Equipment for the automatic staining of biological samples according to claim 39, further comprising dosing means for dosing the stains/reagents in the tray.

44. Equipment for the automatic staining of biological samples according to claim 43, wherein said dosing means are represented by a dosing syringe.

45. Equipment for the automatic staining of biological samples according to claim 39, further comprising means of checking the level of stains/reagents in the tray.

46. Equipment for the automatic staining of biological samples according to claim 45, wherein said means of checking the level of stains/reagents in the tray are represented by an infrared sensor.

47. Equipment for the automatic staining of biological samples according to claim 39, wherein said drive means further comprise an end-effector able to move thanks to its own drive system.

48. Equipment for the automatic staining of biological samples according to claim 47, wherein said end-effector comprises further means for coupling or releasing the basket.

49. Equipment for the automatic staining of biological samples according to claim 39, wherein said means for maintaining and replacing the reagent/stain in the tray comprise means of filling and/or emptying the tray with a stain/reagent.

50. Equipment for the automatic staining of biological samples according to claim 49, wherein said means of filling comprises part of the distribution circuit of the stain/reagent from the reservoirs of the new reagents/stains.

51. Equipment for the automatic staining of biological samples according to claim 49, wherein said means of emptying the tray comprise the distribution circuit from the tray to the disposal reservoirs of the used reagents/stains or to the drains.

52. Equipment for the automatic staining of biological samples according to claim 39, wherein said drive means of the tray comprise further means for washing and/or drying the tray.

53. Equipment for the automatic staining of biological samples according to claim 52, wherein said means of washing the tray comprise part of a distribution circuit for washing the tray with a suitable cleaning reagent and/or water.

54. Equipment for the automatic staining of biological samples according to claim 52, wherein said means for drying the tray comprise a circuit for blowing compressed air, optionally heated, into the tray.

55. Equipment for the automatic staining of biological samples according to claim 39, wherein said automatic maintenance and replacement system controls the filling and emptying operations of the tray with/from reagent/stain, emptying of the distribution system, washing of the tray, drying of the tray.

56. Equipment for the automatic staining of biological samples according to claim 39, wherein said automatic maintenance and replacement system comprises a central control system comprising:
(i) an input user interface;
(ii) an output user interface;
(iii) a memory unit;
(iv) a plurality of control units;
(v) a processing unit; and
(vi) a command unit.

57. Equipment for the automatic staining of biological samples according to claim 39, wherein said tray has a concave bottom.
